(19) United States
(12) Patent Application Publication
(10) Pub. No.: US 2009/0282484 A1
(43) Pub. Date: Nov. 12, 2009

(54) COMPUTER SECURITY

(75) Inventors: Simon Robert Wiseman, Worcestershire (GB); Richard Andrew Oak, Worcestershire (GB)

Correspondence Address: OLIFF & BERRIDGE, PLC, P.O. BOX 320850, ALEXANDRIA, VA, 22320-4850, US

(73) Assignee: QINETIQ LIMITED, LONDON (GB)

(21) Appl. No.: 12/296,507

(22) PCT Filed: Apr. 12, 2007
(86) PCT No.: PCT/GB2007/001349

§ 371 Date: Oct. 8, 2008

(30) Foreign Application Priority Data
Apr. 13, 2006 (GB) 0607594.9

(51) Int. Cl. G06F 21/00; G06F 12/14

(52) U.S. Cl. 726/24; 726/25; 707/101; 707/E17.044

(57) ABSTRACT

Method and apparatus for mitigating the effects of security threat involving malicious code concealed in computer files (for example computer viruses, etc.). The method operates by inserting additional strings of arbitrary length within computer files of known type which may contain such security threats. The strings are chosen to have no substantial effect on the files in normal operation, but potentially disrupt attack code located in the file. Inserted sequences may incorporate a character sequence which, if interpreted as code, halts execution of that program. Alternatively, or in addition, character sequences may be deleted or reordered provided that they have no effect on normal interpretation of the file. As a result, the effect of malicious code operating successfully as intended by an attacker may be mitigated. The methods do not require prior knowledge of the nature of a specific threat and so provide threat mitigation for previously unidentified threats.

### FIELD OF THE INVENTION

The present invention relates to apparatus, methods, signals, and programs for a computer for security purposes in particular, though not exclusively, for protection against malicious attack by computer viruses etc., and systems incorporating the same.

### BACKGROUND TO THE INVENTION

In many computer architectures there is no distinction between code and ordinary data. All data can be interpreted as code if an application or server chooses to do so, and all data can be manipulated and edited as ordinary data. Consequently comprehensive checks which aim to block code are difficult to implement.

Furthermore, an attacker may disguise code as ordinary data in order to introduce it into a system. For example, executables for the Microsoft® Windows® operating system can be created solely from printable characters. Such files can then be passed off as ordinary text and thus introduced into a system where it may subsequently be executed as executable code. This may involve collusion between an entity external to the system creating and sending the file and an entity, human or automated, within the system which can identify such files and cause them to be executed.

By way of example, the text shown below, when interpreted as code rather than mere text, is executable on Windows:
X5O!P%@AP[4\PZX54(P̂)7CC)7}$This is just simple executable text$H+H*

The text itself is not particularly readable, though it is made up solely of printable characters. However, if executed, it prints the message “This is just simple executable text”. In this example an innocuous effect, but in practice much more damaging executable code may be introduced in this way.

Another consequence of the fact that code and data are potentially indistinguishable—both being encoded merely as a series of bytes—is that faults in the way applications programs are designed or implemented can mean that they may cause the data they handle to be executed as code. Such behaviour can be exploited by an attacker to have their own code executed on a victim's computer.

By way of example, one common programming error that can lead to data being executed as code is a buffer overflow. This is where an application attempts to copy input data into a buffer that is too small to hold it, and there are no built-in checks to ensure that copying does not extend beyond the boundaries of the buffer. As a result some of the data will be copied into memory located following the buffer and intended to contain application program variables. In cases in which these variables hold pointers to code which the application will refer to later, an attacker can use this behaviour to attack the application by carefully crafting some over-long data specifically calculated to replace the contents of the pointer variable with a pointer to some of the data just copied and also which originates from the attacker. When the application next attempts to use that location as a pointer to its own code, it inadvertently runs the attackers code instead.

FIG. 1 shows schematically a simple example of how such a simple buffer overflow attack works. The top half of the diagram shows the original state before the application reads in the over-long data. The buffer 10 is located in memory before a location 11 holding an application code pointer 12a to application code 13 to be executed.

Referring now to the lower portion of FIG. 1, an attacker introduces an overly-long data file 14 which is to long to fit in the defined buffer which is too small to hold an attacker's data is followed by a pointer to some code. Upon copying the large amount of data into the small buffer, the original pointer location 11 is overwritten by some of the copied attacker's data. The attacker carefully chooses values for the data so that the pointer value 12b now refers to some 14a of the data just copied, and at this location the attacker arranges to place some executable code. Consequently, when the application follows the pointer to execute its code 13, it will instead execute the attacker's code 14a.

A first know approach to protection against attack is malicious software detection. In some forms of such attack involving malicious software (e.g. computer viruses) it may be possible to identify particular value strings present in the files containing the attack code by means of which the presence of such viruses may be determined. A number of existing computer security products adopt this approach to screen files received from external systems, or indeed to screen files present within the system at any time. The approach involves maintenance of a catalogue of known characteristics of malicious code which must be maintained in each user system.

A problem with that approach is that it relies on prior knowledge of characterising byte strings associated with such attacks. As a consequence the approach is typically ineffective against newly created forms of attack which do not contain previously identified characterising byte strings, thereby allowing such new forms of attack to propagate until the attack is characterised and suitable definitions distributed to user systems.

Another known approach is behaviour blocking. In this approach, rather than relying on blocking the introduction of undesirable code, it is possible to monitor the execution of applications and constrain their behaviour. The principle behind this approach is that the normal behaviour of applications can be determined and then the actual behaviour compared against this. If actual behaviour deviates from the norm, monitoring software can intervene and block the undesired actions.

For example, a word processor may not normally send instant messages, so if it does this would be considered unusual behaviour for word processing software and therefore treated as indicative of an attack and monitoring software would therefore block its execution.

A problem with this approach is that the technique is difficult to implement in general since it must integrate closely with each instance of application and server software. Furthermore, the system must be configured or trained to learn the normal behaviour of the system it is defending: if new software is introduced, the monitoring software cannot defend against misbehaviour of that software until it has been configured to do so.

### SUMMARY OF THE INVENTION

A principle of the present invention is that potentially malicious code is disrupted by varying the length of the files through introduction or removal of byte strings which do not substantially affect “normal” interpretation of those files but which do have a disrupting effect upon attempted execution of those files, or portions of them.

In general, code may be injected into the data (or deleted or the data otherwise changed in length) passing from an external (or unprotected part of a) system to the protected part of a system in order to disrupt the behaviour of any attack code contained in the data. This injection may be performed at any one of a number of points in the system or during transfer of data; for example in a firewall or similar system-interface location, or at the point at which a file is opened for reading or other similar point.

Such changes may be made for example, to XML, Rich Text (RTF), and other documents that are disguised forms of Windows executable and can be protected in this way.

In particular, according to a first aspect of the present invention there is provided a method of mitigating the effect of a security threat present in a computer file of known type, the method comprising inserting in and/or deleting from the file one or more character strings the effect of which insertions and/or deletions, individually or in combination, have no substantial effect on the interpretation of the file when interpreted in accordance with its known type.

By inserting or deleting such strings of arbitrary length into the files, normal use of the file is unaffected (other than that the file is a lengthened). However subsequent attempted execution of malicious code hidden within the file and containing references to specific points within the file beyond the point of insertion of the character strings is potentially disrupted since code originally resident at those points is no longer located at that point. The length of strings modified may vary over time to further reduce predictability from the point of view of the attacker.

In some embodiments at least one of the character strings is inserted at the earliest point in the file at which such a string can be inserted.

By inserting a character string early in the file, and most preferably at the earliest possible point, the likelihood of disrupting malicious code within the file is increased.

In some embodiments at least one portion of one of the character strings is selected such that if that portion were interpreted as executable program code then that portion would cause termination or infinite looping of the program code.

By incorporating termination or looping sequences within the inserted character strings, execution of that portion of the file as a result of execution of malicious code hidden within the file will result in termination or infinite looping of the code, thereby limiting potential damage wrought by the malicious code.

In some embodiments the known type is one of RTF and XML.

These are examples of known file types which may be used to conceal malicious code. The present method is by no means limited only to such file types, and other known types will be apparent to the skilled person.

In some embodiments the method further comprises subsequently identifying the location of one or more of the inserted character strings and deleting them, at least in part, from the file prior to saving or forwarding the file and in such a way that any remaining partial character strings, individually or in combination, have no substantial effect on the interpretation of the file when interpreted in accordance with its known type.

By allowing for deletion, or at least shortening, of inserted character strings it is possible to mitigate the effects of repeated insertion of character strings which would otherwise tend to monotonically increase the size of files treated in this way.

In some embodiments the character strings are inserted upon receipt of the file from a logically or physically remote system or user.

In this way files may be conveniently processed upon first receipt, for example via email an subsequently viewed, executed, or otherwise opened. This may be performed for example in a firewall or at other system interface.

In some embodiments the character strings are inserted upon opening the file for interpretation.

In this way files may be processed on each occasion they are viewed, executed, or otherwise opened. In this mode the code required for character string insertion may be conveniently incorporated in the application program invoked to view, execute, or otherwise open the file. This may act to mitigate the effect of any malicious code which might be inserted after, for example a file has been processed upon first receipt but before opening.

In some embodiments the method comprises deleting from the file one or more character strings whose deletion, individually or in combination, have no substantial effect on the interpretation of the file when interpreted in accordance with its known type.

Text deletion may also act to disrupt malicious code embodied in the file.

In some embodiments the insertion or deletion is applied to pre-determined fields within the file and which may be defined within the known standard file type definition for that purpose.

According to a further aspect of the present invention there is provided a method of mitigating the effect of a security threat present in a computer file of known type, the method comprising reordering one or more character strings located within the file the effect of which reorderings, individually or in combination, have no substantial effect on the interpretation of the file when interpreted in accordance with its known type.

Such reorderings may serve to disrupt the location of pointers and the execution sequence of data intended to act as attack code.

The invention also provides for a system for the purposes of communications which comprises one or more instances of apparatus embodying the present invention, together with other additional apparatus.

In particular, according to a further aspect of the present invention there is provided apparatus for mitigating the effect of security threat present in a computer file of known type, the apparatus comprising means for inserting in and/or deleting from the file one or more character strings the effect of which insertions and/or deletions, individually or in combination, have no substantial effect on the interpretation of the file when interpreted in accordance with its known type.

The invention also provides for computer software in a machine-readable form and arranged, in operation, to carry out every function of the apparatus and/or methods. In this context the computer program is also intended to encompass hardware description code used to describe, simulate or implement chip and/or circuit layout used to implement the present invention.

In particular, according to a further aspect of the present invention there is provided a program for a computer for mitigating the effect of security threat present in a computer file of known type, the program comprising code portions for inserting in and/or deleting from the file one or more character strings the effect of which insertions and/or deletions, individually or in combination, have no substantial effect on the interpretation of the file when interpreted in accordance with its known type.

The invention is also directed to novel signals employed in the operation of the invention or containing data processed in accordance with the methods.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1 shows schematically an example of malicious attack;

FIG. 2 shows a first example of an attack disrupting method according to the present invention;

FIG. 3 shows a second example of an attack disrupting method according to the present invention;

FIG. 4 shows a schematic diagram of a first system (or corresponding program for a computer) according to the present invention;

FIG. 5 show a flow diagram of a further method according to the present invention.

### DETAILED DESCRIPTION OF INVENTION

Rather than attempt to identify and block data that is potentially undesirable code from entering a system, the present invention provides an alternative approach by modifying the data admitted to the system so as to mitigate the potential effects of the data being executed. An attacker is thereby denied the opportunity of introducing into a system code that will assuredly serve their purposes.

The modifications aim to disrupt any attack code, including pointers, provided by the attacker by injecting code sequences into it that render it inert or otherwise ineffective.

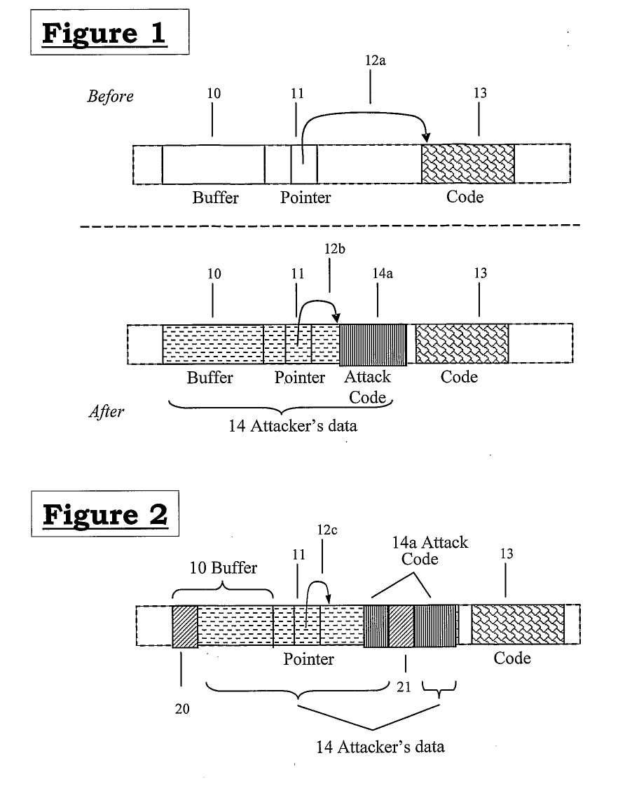

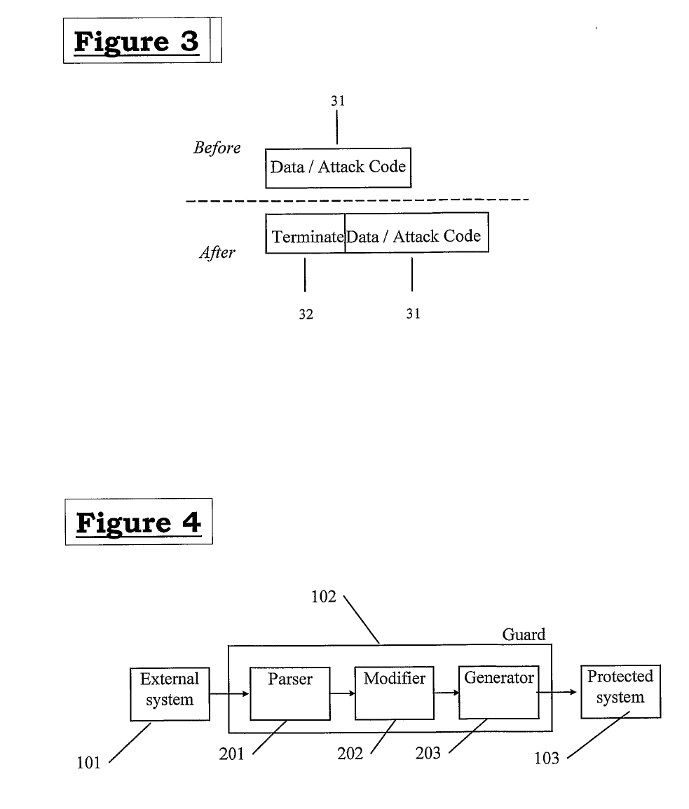

Referring now to FIG. 2, based on the example of FIG. 1, additional byte (or character) strings 20, 21 are introduced at one or more points into the data file 14. As a result one or more portions of the attacker's data 14 including attack code 14a are relocated with respect to at least one of the buffer 10 and pointer location 11.

Different cases arise:
One or more byte strings 20 are introduced before the pointer location 11: As a result the value of original pointer 12a is no longer assuredly changed to the attacker's choice of pointer value 12b, but rather to an arbitrary value 12c determined by the byte value relocated to the pointer location by the insertion of the byte strings. The new value may in practice point forward or back, but in either case the likelihood of its pointing to a successfully executable byte sequence—including the attacker's code—is limited.
One or more byte strings 21 is introduced only in the body of the attack code 14a: As a result the effect of the attack code becomes unlike that intended by the attacker. In this case it is desirable to introduce byte strings which, if executed, cause a known or predictable effect and which most preferably precludes further execution of the attack code. For example halting of the program, infinite looping, or cause the program to crash or abort. In other cases it may be possible to introduce code which displays a specific error message to the user or logs the problem to a system log file before terminating etc.
One or more byte strings is introduced before the pointer and in the body of the attack code: In thus case the benefits of both forms of attack disruption may be achieved. Since in general the locations of attack code and pointer values are unpredictable, it is desirable to introduce byte strings which, if executed, cause a known or predictable effect and which most preferably precludes further execution of the attack code at each point.

Whilst the method has been described above has been described in terms of introducing byte strings, it will be apparent to the skilled person that a similar effect may be achieved in some cases by deleting byte strings where, again, preferably no substantial effect is introduced when the data is interpreted normally.

Furthermore the methods of introducing and removing byte strings may be combined, though care should be taken that the cumulative effect of introduction and deletion of strings does not result at any point in the file in the original data remaining in the same location.

One method of implementing this approach in files of known type is through use of a specific pre-defined field type which may take one or more arguments of variable length. In this way it would be possible to locate one or more such fields in any file from its creation. Subsequent processing by means of the methods described may be achieved simply by varying the contents of the argument fields to increase or decrease their lengths and hence unpredictably disrupt any attack code.

Referring now to FIG. 3, for cases in which an attack is introduced disguised as a text file 31 and the file subsequently executed, the simplest form of this modification is to place a terminate instruction 32, or an infinite loop within the file, preferably at the beginning of the file. Alternatively any other byte string may be used which, if executed, causes a known or predictable effect and which most preferably precludes further execution of the attack code supplied by the attacker. Then, if the data is executed, it will either immediately terminate or never progress to reach the attacker's code.

If the original data/attack code 31 is executed, the attacker's code will run. However, if an attempt is made to execute the modified file, comprising termination instruction 32 and attacker's code 31, the application will immediately terminate and the attacker's code will not be run.

This simple modification of the start of the attacker's data works if the data is executed at the beginning, which would be the case where an executable file is disguised as text. However, some attacks will start to execute the data at some arbitrary point. In such cases such a simple modification may be bypassed and the attacker's code still execute.

A more complicated modification can handle such cases by injecting terminate sequences wherever the application associated with the notional file type (for example text file, RTF, XML, GIF, JPEG, BMP, EPS, or PDF types) will ignore them. For example, an XML document can contain comments which an XML application program will ignore, so comments containing terminate sequences may be injected at arbitrary points into an XML document without changing its meaning. The effect of this is to reduce the opportunity an attacker has to create and successfully introduce useful attack code sequences.

Referring now to FIG. 4 a system embodying the invention is illustrated, showing how for example RTF or XML format documents could be modified to disrupt their behaviour if they are treated as Windows operating system executables running on an Intel processor.

Data in the form of RTF or XML files is sent into a protected system (or part of a system) 103 from an external system (or part of a system) 101 which is controlled by an attacker, or is at least not defended form the attacker. The guard system 102 located between the two systems imposes checks on the data and modifies it to mitigate the effects of any attack code contained in the data.

The guard 102 comprises a number of components. The parser 201 receives the data as a sequence of bytes from the external system 101 and extracts its structure by parsing it. The parsed form of the data is passed to the modifier 202. This component is responsible for injecting code sequences into the parsed data (or extending or reducing previously injected code sequences). The modifier is guided by the structure of the data that has been exposed by the parser, so as to ensure that the modifications made have no effect on the way applications will interpret the data in normal use. Having been modified, the data is passed to the generator 203. This reverses the parsing process, by reconstructing the data as a sequence of bytes, which is passed on to the protected system 103.

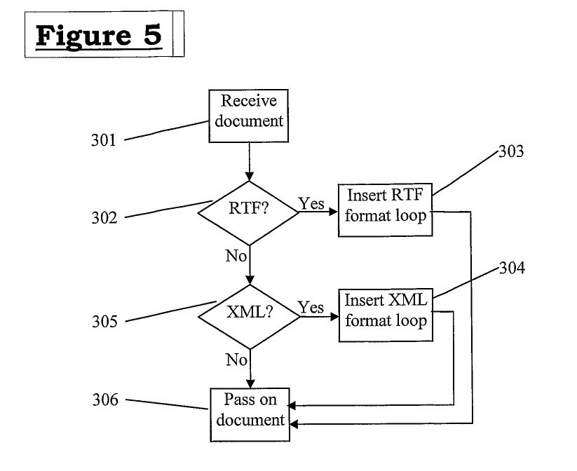

Referring now to FIG. 5, the modifier 202 makes a modification to the parsed data according to its type. The modifier receives 301 the parsed document from the parser 201. It then checks 302 whether the document is in Rich Text Format (RTF). If so, it modifies 303 the RTF data as described above; otherwise checks 305 whether the document is in eXtensible Markup Language (XML) format. If so, it modifies it according to the rules for XML formal documents as described above. Documents of other predefined types may be processed similarly.

If the document type is not RTF or XML, it is passed on unmodified. This would be the case for document formats where it is known that they cannot be executed and so do not need to be disrupted.

By way of example regarding processing of document allegedly in RTF format, such documents start with text such as the following;
{\rtf1\ansi

One possible modification according to the methods described above would change the above text to appear as follows instead:
{\rtf1{\*\S jhX,hPY; 2 [symbol] t Bard!!@ABCDEFGHIJKLMNO
AABCDEFGHIJKLMNOBABCDEFGHIJKLMNOCABCDEF
GHIjhX,hPY; 2 [symbol] t Bard!!BljhX,hPY; 2 [symbol] t Bard!!}\ansi

This modification introduces a new RTF tag, called “S”, which no existing applications understand. This tag is also preceded by the string “\*”, to indicate that applications should ignore the tag. Thus in effect the new text is a comment which is ignored by all RTF applications in normal operation.

However, if interpreted as instructions for an Intel processor, this data would have the following meaning:

| | |
|---|---|
| {\ | // jnp 5ch |
| rt | // jb 74h |
| f1{\ | // xor word ptr [ebx+5Ch],di |
| *\S | // sub bl,byte ptr [ebx+edx*2+20h] |
| jh | // label1: push 68 |
| X | // pop eax |
| ,h | // sub al, 68h |
| P | // push eax |
| Y | // pop ecx |
| ;\x08 | // cmp ecx, dword ptr [eax] |
| 2\xc9 | // xor cl, cl |
| \x90 | // nop |
| t\xf2 | // jz label1 |
| \x80\x80\x80 Bar | // add byte ptr [eax+61422080h],72h |
| d!! | // and dword ptr fs:[ecx],esp |
| @ABCDEFGHIJKLMNO | // inc and dec all registers in turn.... |
| AABCDEFGHIJKLMNO | // ... which is padding for the jumps |
| BABCDEFGHIJKLMNO | // |
| CABCDEFGHI | // |
| jh | // label2: push 68 |
| X | // pop eax |
| ,h | // sub al, 68h |
| P | // push eax |
| Y | // pop ecx |
| ;\x08 | // cmp ecx, dword ptr [eax] |
| 2\xc9 | // xor cl, cl |
| \x90 | // nop |
| t\xf2 | // jz label2 |
| \x80\x80\x80 Bar | // add byte ptr [eax+61422080h],72h |
| d!! | // and dword ptr fs:[ecx],esp |
| Bl | // inc dec EDX (padding between loops |
| jh | // label3: push 68 |
| X | // pop eax |
| ,h | // sub al, 68h |
| P | // push eax |
| Y | // pop ecx |
| ;\x08 | // cmp ecx, dword ptr [eax] |
| 2\xc9 | // xor cl, cl |
| \x90 | // nop |
| t\xf2 | // jz label3 |
| \x80\x80\x80 Bar | // add byte ptr [eax+61422080h],72h |
| d!!} | // and dword ptr fs:[ecx],esp |

The code therefore has the effect of an infinite loop which, other than consuming processor resources, is harmless. The loop is in this instance complicated because it must start with the characters “{rtf1{\*\”. Interpreted as code, this means the code starts with a conditional jump instruction, so the injected code must deal with this by ensuring that whichever way the jump goes the code will loop back. Also, the characters used have to conform to various constraints imposed by the RTF syntax, for example the absence of unbalanced {and} characters and the need for the text to be entirely valid Unicode character encodings.

By way of a further example relating to XML documents, step 304 is performed if the document is in XML format. XML documents allow comments to occur at the start of the document. Comments are generally ignored by applications, so can be injected without changing the meaning of the document. Comments in XML have the following form:
<!--the comment-->

One possible modification is to change the text to inject the following comment at the start:
<!--SyjhX,hPY; 2 [symbol] t Bard!!%-->

If interpreted as instructions for the Intel processor, this data has the following meaning:

| | |
|---|---|
| <! | // cmp al, 21h |
| -- Sy | // sub eax, 7953202dh |
| jh | // label: push 68 |
| X | // pop eax |
| ,h | // sub al, 68h |
| P | // push eax |
| Y | // pop ecx |
| ;\x09 | // cmp ecx, dword ptr [ecx] |
| 2\xc9 | // xor cl, cl |
| \x90 | // nop |
| t\xf2 | // jz label |
| \x80\x80\x80 Bar | // add byte ptr [eax+61422080h],72h |
| d!!″ | // and dword ptr fs:[ecx],esp |
| % --> | // and eax,3E2D2D20h |

The code is an infinite loop that also attempts to access location zero. This location is often inaccessible and would typically result in the program being terminated by the operating system, rather than looping indefinitely.

The modifications described only place disruptive code at the start of the document. In both examples, however, the injected data acts as a comment and so could be placed anywhere that such a comment is valid. This would help protect against attacks where execution of the document's data starts at some arbitrary point.

Also in some cases, particularly XML, it is possible to reorder data without modifying the way applications interpret it. If this is done arbitrarily, it would have the benefit of making it still more difficult for an attacker to string useful code sequences together. By applying this reordering of data once again the likelihood of either relocating pointer away form its intended position or disrupting the execution sequence of attack code is increased.

The points in any system at which the methods may be applied are various and may be used singly or in combination:
Code may be disrupted within a software or hardware firewall or other peripheral point in a system to mitigate the effects of any potentially disruptive code entering the system protected by the firewall.
Code may be disrupted from within application programs intended to view or otherwise open a file. In this way the disruption methods are invoked each time a file is opened so that not only is attack code disrupted, it is potentially disrupted in arbitrarily different ways on each occasion upon which the file is opened, hence introducing still further uncertainty from an attacker's point of view.
Code may be disrupted at any other point, for example by a background system task, analogous to existing anti-virus programs which periodically scan the entire discs for affected files, but in this case whose purpose is to identify and modify files susceptible to attack as described above.

The latter two approaches may be desirable where there is a risk that a previously modified file may subsequently have been re-infected by a virus.

It is also desirable to provide methods which are capable of removing, or at least reducing the size of, character sequences introduced by the methods described above. This will involve corresponding steps of parsing and modifying the data to identify and remove inserted strings. Specific details of this suitable processes would be apparent to the skilled person. By providing the ability to remove inserted strings, this mitigates the undesirable effect of continually lengthening files which might otherwise occur where a data file is passed along a chain of systems each of which processes it to insert disruptive byte sequences.

Any range or device value given herein may be extended or altered without losing the effect sought, as will be apparent to the skilled person for an understanding of the teachings herein.

1. A method of mitigating the effect of a security threat present in a computer file of known type, the method comprising inserting in and/or deleting from the file one or more character strings the effect of which insertions and/or deletions, individually or in combination, have no substantial effect on the interpretation of the file when interpreted in accordance with its known type.

2. A method according to claim 1 in which at least one of the character strings is inserted at the earliest point in the file at which such a string can be inserted.

3. A method according to claim 1 in which at least one portion of one of the character strings is selected such that if that portion were interpreted as executable program code then that portion would cause termination or infinite looping of the program code.

4. A method according to claim 1 in which the known type is one of RTF and XML.

5. A method according to claim 1 further comprising subsequently identifying the location of one or more of the inserted character strings and deleting them, at least in part, from the file prior to saving or forwarding the file and in such a way that any remaining partial character strings, individually or in combination, have no substantial effect on the interpretation of the file when interpreted in accordance with its known type.

6. A method according to claim 1 in which the character strings are inserted upon receipt of the file from a logically or physically remote system or user.

7. A method according to claim 1 in which the character strings are inserted upon opening the file for interpretation.

8. A method of mitigating the effect of a security threat present in a computer file of known type, the method comprising deleting from the file one or more character strings whose deletion, individually or in combination, have no substantial effect on the interpretation of the file when interpreted in accordance with its known type.

9. A method according to claim 1 in which the insertion or deletion is applied to predetermined fields within the file which are defined within the known standard file type definition for that purpose.

10. A method of mitigating the effect of a security threat present in a computer file of known type, the method comprising reordering one or more character strings located within the file the effect of which reorderings, individually or in combination, have no substantial effect on the interpretation of the file when interpreted in accordance with its known type.

11. Apparatus for mitigating the effect of security threat present in a computer file of known type, the apparatus comprising means for inserting in and/or deleting from the file one or more character strings the effect of which insertions and/or deletions, individually or in combination, have no substantial effect on the interpretation of the file when interpreted in accordance with its known type.

12. A program embodied on a computer readable medium for mitigating the effect of security threat present in a computer file of known type, the program comprising code portions that cause a computer to execute a process for inserting in and/or deleting from the file one or more character strings the effect of which insertions and/or deletions, individually or in combination, have no substantial effect on the interpretation of the file when interpreted in accordance with its known type.

13-16. (canceled)
